(19) United States
(12) Patent Application Publication
(10) Pub. No.: US 2014/0023502 A1
(43) Pub. Date: Jan. 23, 2014

(54) VARIABLE VANE ASSEMBLY FOR TURBINE SYSTEM

(71) Applicant: William Earl Dixon, Greer, SC (US)

(72) Inventor: William Earl Dixon, Greer, SC (US)

(73) Assignee: GENERAL ELECTRIC COMPANY, Schenectady, NY (US)

(21) Appl. No.: 13/554,388

(22) Filed: Jul. 20, 2012

(51) Int. Cl. F01D 5/00; B23P 15/00

(52) U.S. Cl. 416/131; 29/888.025

(57) ABSTRACT

Variable vane assemblies and methods for removing and assembling variable vane assemblies in turbine systems are provided. In one embodiment, a variable vane assembly includes a variable stator vane and an outer casing. A generally annular ring channel is defined in the outer casing. The variable vane assembly further includes a ring segment disposed in the ring channel, and a stem extending from a radially outer end of the variable stator vane at least partially through the ring segment. In another embodiment, a variable vane assembly includes a variable stator vane and a ring segment. The variable vane assembly further includes a stem extending from a radially outer end of the variable stator vane and configured to extend at least partially through the ring segment, and a stem extension configured to couple with the stem and protrude from the ring segment.

### FIELD OF THE INVENTION

The present subject matter relates generally to turbine systems and, more particularly, to variable vane assemblies for turbine systems and methods for removing and assembling variable vane assemblies in turbine systems.

### BACKGROUND OF THE INVENTION

Turbine systems are widely utilized in fields such as power generation. For example, a conventional gas turbine system includes a compressor section, a combustor section, and at least one turbine section. The compressor section is configured to compress air as the air flows through the compressor section. The air is then flowed from the compressor section to the combustor section, where it is mixed with fuel and combusted, generating a hot gas flow. The hot gas flow is provided to the turbine section, which utilizes the hot gas flow by extracting energy from it to power the compressor, an electrical generator, and other various loads.

A typical compressor for a gas turbine may be configured as a multi-stage axial compressor and may include both rotating and stationary components. A shaft drives a central rotor drum or wheel, which has a number of annular rotors. Rotor stages of the compressor rotate between a similar number of stationary stator stages, with each rotor stage including a plurality of rotor blades secured to the rotor wheel and each stator stage including a plurality of stator vanes secured to an outer casing of the compressor. During operation, airflow passes through the compressor stages and is sequentially compressed, with each succeeding downstream stage increasing the pressure until the air is discharged from the compressor outlet at a maximum pressure.

In order to improve the performance of a compressor, one or more of the stator stages may include variable stator vanes, or variable vanes, configured to be rotated about their longitudinal or radial axes. Such variable stator vanes generally permit compressor efficiency and operability to be enhanced by controlling the amount of air flowing into and through the compressor by rotating the angle at which the stator vanes are oriented relative to the flow of air. Rotation of the variable stator vanes is generally accomplished by attaching, for example, a lever arm or gear assembly to each stator vane. The lever arms or gear assemblies may be rotated, thereby causing each stator vane to rotate about its radial or longitudinal axis.

During the life of a turbine system, a variable vane may require repair or replacement. Thus, it may be necessary to remove the variable vane from the compressor. Variable vanes are disposed in the compressor between an outer casing and the rotor, to which the rotor stages are attached. To remove a variable vane, an upper outer casing may be separated from a lower outer casing. Presently known designs of compressors then require that the rotor be removed from the lower outer casing before a variable vane can be removed, because presently known variable vane designs require that the vane be moved radially inward from the outer casing to separate the variable vane from the outer casing for removal. Removal of the rotor from the outer casing is a burdensome, time-consuming, and expensive process which may require, for example, operation of a crane to pick up and move the rotor. In many cases, such as during in-field repair or replacement, removal of the rotor may thus be extremely difficult or impossible.

Accordingly, improved variable vane assemblies for turbine systems and improved methods for removing and assembling variable vane assemblies in turbine systems are desired. For example, variable vane assemblies and methods that allow for removal and assembly of the variable vanes while the rotor remains within the lower outer casing would be advantageous.

### BRIEF DESCRIPTION OF THE INVENTION

Aspects and advantages of the invention will be set forth in part in the following description, or may be obvious from the description, or may be learned through practice of the invention.

In one embodiment, the present disclosure is directed to a variable vane assembly for a turbine system. The variable vane assembly includes a variable stator vane comprising a radially inner end, a radially outer end, and a body therebetween, and an outer casing proximate the radially outer end, the outer casing comprising an inner wall, and outer wall, and a body therebetween. A generally annular ring channel is defined in the outer casing, the ring channel extending from the inner wall into the casing. The variable vane assembly further includes a ring segment disposed in the ring channel, and a stem extending from the radially outer end of the variable stator vane at least partially through the ring segment.

In another embodiment, the present disclosure is directed to a variable vane assembly for a turbine system. The variable vane assembly includes a variable stator vane comprising a radially inner end, a radially outer end, and a body therebetween, and a ring segment. The variable vane assembly further includes a stem extending from the radially outer end of the variable stator vane and configured to extend at least partially through the ring segment, and a stem extension configured to couple with the stem and protrude from the ring segment.

In another embodiment, the present disclosure is directed to a method for removing a variable stator vane in a turbine system. The method includes separating an upper outer casing from a lower outer casing, and sliding a ring segment in a ring channel defined in one of the upper outer casing or lower outer casing towards an edge surface of one of the upper outer casing or lower outer casing. The variable stator vane is coupled to the ring segment.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a schematic depiction of a gas turbine;

FIG. 2 provides a cross-sectional view of a variable vane assembly according to one embodiment of the present disclosure; and

FIG. 3 provides a perspective view of a lower outer casing according to one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

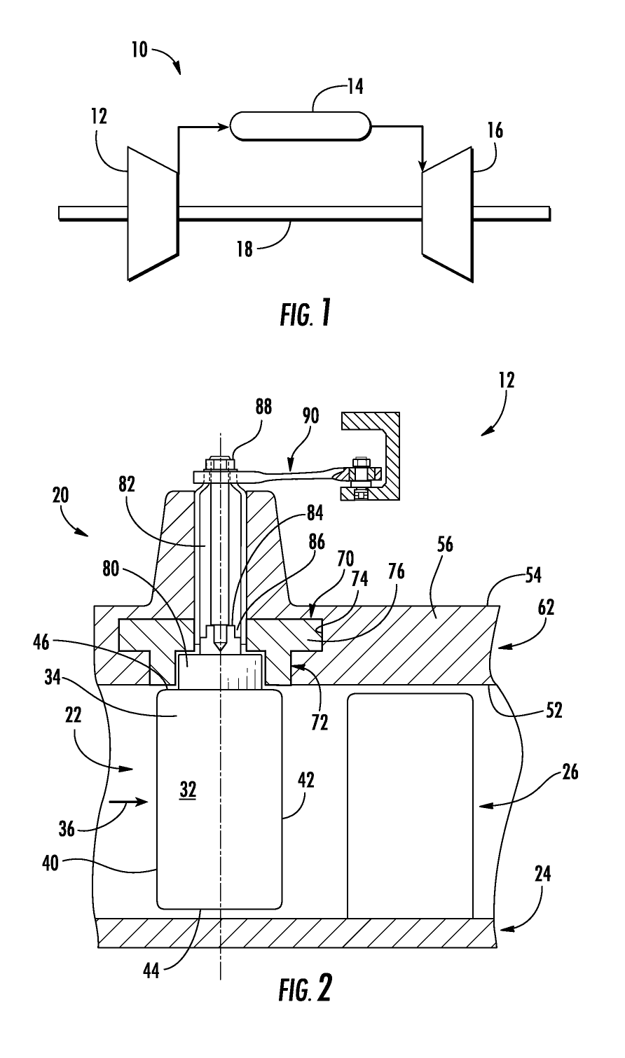

FIG. 1 is a schematic diagram of a gas turbine system 10. It should be understood that the turbine system 10 of the present disclosure need not be a gas turbine system 10, but rather may be any suitable turbine system 10, such as a steam turbine system or other suitable system. The gas turbine system 10 may include a compressor section 12, a combustor section 14, and a turbine section 16. The compressor section 12 and turbine section 16 may be coupled by a shaft 18. The shaft 18 may be a single shaft or a plurality of shaft segments coupled together to form shaft 18. The shaft 18 may further be coupled to a generator or other suitable energy storage device, or may be connected directly to, for example, a pump, processing compressor or other device. Exhaust gases from the system 10 may be exhausted into the atmosphere, flowed to a steam turbine or other suitable system, or recycled through a heat recovery steam generator.

In one embodiment, the compressor section 12 may comprise a multi-stage axial compressor having a plurality of corresponding rotor and stator stages. In such an embodiment, one or more of the stator stages may include a plurality of variable stator vanes. For example, the compressor section 12 may include a plurality of fixed stator vanes in its downstream stages, with the variable stator vanes being disposed in the upstream stages thereof. Alternatively, all of the stator stages of a compressor section 12 may include variable stator vanes.

During operation of the gas turbine 10, the compressor section 12 supplies compressed air to the combustor section 14. Air and fuel are mixed and burned within combustors of the combustor section 14, and hot gases of combustion flow in a hot gas path from the combustor section 14 to the turbine section 16, wherein energy is extracted from the combustion gases to produce work.

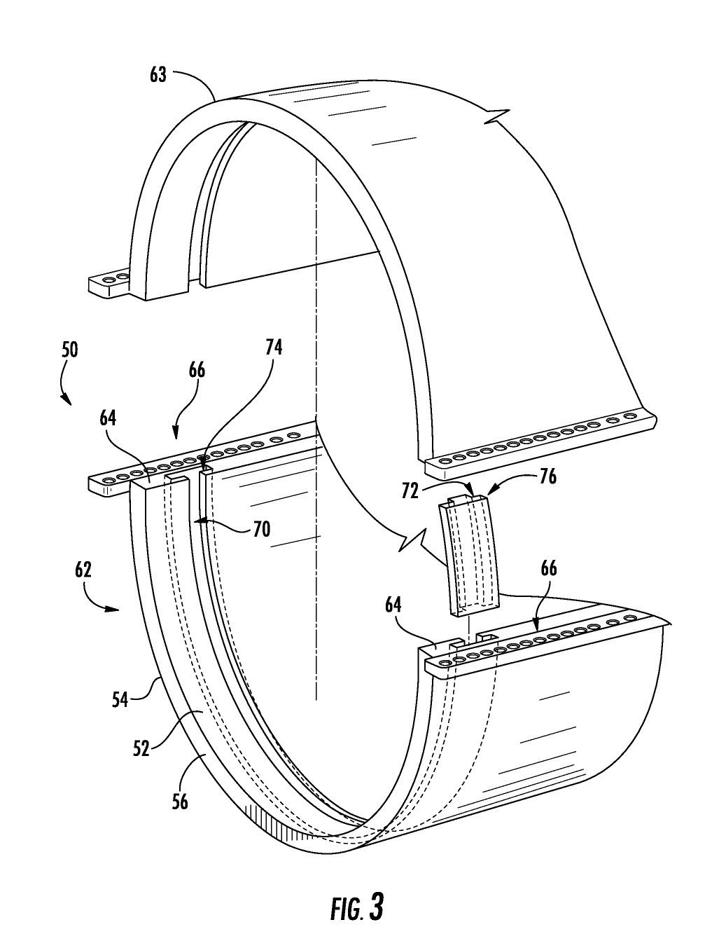

FIG. 2 illustrates a variable vane assembly 20 according to one embodiment of the present disclosure. As shown, the compressor 12 of a gas turbine 10 may include one or more stator stages having a plurality of variable stator vanes 22 (one of which is illustrated) rotatably mounted within an outer casing 50 (see FIG. 3). A rotor 24 may be provided in the outer casing 50, which includes rotor buckets 26 (one of which is illustrated) connected thereto. The rotor 24 may be positioned within the outer casing 50 such that the vanes 22 and buckets 26 are disposed between the rotor 24 and outer casing 50, generally in alternating stages as discussed above. Each variable vane 22 generally includes a body 32, which typically has an airfoil shape having a first or pressure side 34 and a circumferentially opposite second or suction side (not shown) which define the aerodynamic surface of the vane 22 over which air 36 flows during operation of the compressor 12. The pressure and suction sides generally extend axially along a chord between opposite leading and trailing edges 40, 42 and radially span from a radially inner end 44, which may for example be a tip, to a radially outer end 46, which may for example be a root. The body 32 extends between the radially outer end 46 and the radially inner end 44.

As shown in FIGS. 2 and 3, the variable stator vanes 22 are disposed within an outer casing 50. When within the outer casing 50, the outer casing 50 may be proximate the radially outer end 46 of each variable stator vane 22. The outer casing 50 has an inner wall 52 and an outer wall 54, with a body 56 extending therebetween. In exemplary embodiments, the outer casing 50 is generally cylindrically shaped, with a generally circular or oval-shaped cross-sectional profile, having a generally curvilinear inner wall 52 and outer wall 54.

The outer casing 50 in exemplary embodiments further includes a lower outer casing 62 and an upper outer casing 63. The lower outer casing 62 and upper outer casing 63 may include edge surfaces defining the outer boundaries of the casings, and some of which may mate together to form outer casing 50. For example, edge surfaces 64 at respective horizontal joints 66 of the lower outer casing 62 and upper outer casing 63 may mate together to form the outer casing 50. Mechanical fasteners, such as nut-bolt combinations or other suitable mechanical fasteners, may be utilized to fasten the lower outer casing 62 and upper outer casing 63 together at the horizontal joints 66.

As further shown in FIGS. 2 and 3, a ring channel 70 may be defined in the outer casing 50. The ring channel 70 extends from the inner wall 52 into the casing 50, such as into the body 56 thereof. In exemplary embodiments, the ring channel 70 is generally annular, and thus extends at least partially in a generally circumferential direction around and through the body 56. As shown, for example, the ring channel 70 may extend circumferentially through the body 56 of the lower outer casing 62. The ring channel 70 may in some embodiments further extend circumferentially through the body 56 of the upper outer casing 63, such that the ring channel 70 is a continuous annular channel.

One or more ring segments 72 may be provided, each of which may be configured to fit within the ring channel 70 and move through the ring channel 70, such as towards an edge surface. Thus, when assembled, a ring segment 72 may be disposed within the ring channel 70. Each ring segment 72 may be sized and shaped to fit within the ring channel 70. Further, ring segments 72 may be sized such that the ring channel 70 can accommodate one or more ring segments 72. For example, the portion of the ring channel 70 defined in the lower outer casing 62 may accommodate one ring segment 72 that extends through the entire ring channel 70, or more than one ring segment 72 that together extend through the entire ring channel 70. When fully assembled, the ring segments 72 disposed in the ring channel 70 may extend through the entire ring channel 70 or any portion thereof.

In exemplary embodiments, the ring channel 70 may include a dovetail slot 74 or other suitable female coupling portion. This slot 74 or portion may in exemplary embodiments as shown be the portion of the ring channel 70 furthest from the inner wall 52. Alternatively, the slot 74 or portion may be any suitable portion of the ring channel 70. The ring segments 72 may include dovetails 76 or other suitable male coupling portions configured to couple with the dovetail slot 74 or other suitable female coupling portion, thus coupling the ring segments 72 to the ring channel 70 such that the ring segments 72 are movably retained within the ring channel 70. When movably retained, a ring segment 72 can move, such as slide, within the ring channel 70 such as in the circumferential direction, but are generally retained in and thus generally cannot move in, for example, the radial direction.

As shown in FIG. 2, a stem 80 may extend from the variable stator vane 22. For example, a stem 80 may extend generally radially outwardly from the radially outer end 46 of the vane 22. The stem 80 may be fastened to the vane 22, such as through the use of a suitable mechanical fastener or through welding or another suitable fastening process or apparatus, or may be integral with the vane 22. The stem 80 further may extend at least partially through an associated ring segment 72, thus coupling the vane 22 to the ring segment 72. It should be noted that one or more vanes 22 may be coupled to each ring segment 72.

In some embodiments, the stem 80 may extend in the generally radial direction entirely through the ring segment 72. In other embodiments, the stem 80 may extend in the generally radial direction partially through the ring segment 72. Further, a variable vane assembly 20 according to the present disclosure may include a stem extension 82 configured for coupling with the stem 80. When assembled, the stem extension 82 may extend radially inward through the casing 50, such as through the body 56 thereof, from the outer wall 54 towards the inner wall 52. Further, in embodiments wherein the stem 80 extends only partially through the ring segment 72, the stem extension 82 may extend partially through the ring segment 72 to couple with the stem 80. In exemplary embodiments as shown, the stem extension 82 protrudes from the outer wall 54 of the casing 50. In other embodiments, a radially outer end of the stem extension 82 may be flush with the outer wall 54 or within the body 56.

When assembled, the stem 80 and stem extension 82 are coupled together. For example, one of the stem 80 or stem extension 82 may include a male coupling feature 84, and the other of the stem 80 or stem extension 82 may include a mating female coupling feature 86. In exemplary embodiments as shown, the stem 80 includes the male coupling feature 84 and the stem extension 82 includes the mating female coupling feature 86. The coupling features 84, 86 may be sized and shaped such that, when assembled, the male coupling feature 84 generally fits within the female feature 86, coupling the stem 80 and stem extension 82 together.

In some embodiments, as shown in FIG. 2, a mechanical fastener 88 may be provided for fastening the stem 80 and stem extension 82 together. The mechanical fastener 88 may be, for example, a bolt, screw, nail, rivet, or other suitable fastening apparatus. The mechanical fastener 88 may, for example, extend through the stem extension 82 into the stem 80 to fasten the stem extension 82 and stem 80 together.

As discussed, the variable stator vanes 22 may each rotate about a generally radial axis extending through the body 32 of each vane 22. In some embodiments, a variable vane assembly 20 may thus include a vane arm 90. The vane arm 90 may be rotatably coupled to the vane 22, such as through rotational coupling to the stem extension 82. Rotation of the vane arm 90 may rotate the stem extension 82, thereby causing rotation of the stem 80 and thus the vane 22. Alternatively, a gear assembly or any other suitable rotational apparatus may be coupled to the vane 22, such as to the stem extension 82.

Variable vane assemblies 20 according to the present disclosure facilitate efficient and cost-effective removal and assembly of variable stator vanes 22. Further, such variable vane assemblies 20 allow for removal and assembly of vanes 22 while the rotor 24 of the turbine system 10 remains within the outer casing 50, such as within the lower outer casing 62. For example, the upper outer casing 63 may be separated from the lower outer casing 62 to provide access to the vanes 22. However, the vanes 22 can then be removed from the lower outer casing 62 (as well as from the upper outer casing 63) without requiring removal of the rotor 24 from the lower outer casing 62. Such advantageous removal and assembly of the vanes 22 is facilitated by the inclusion in the variable vane assemblies 20 of ring segments 72, which the vanes 22 are coupled to. The ring segments 72 move, such as slide, within ring channels 70. Such movement in exemplary embodiments is generally annular or circumferential about the casing 50, such as towards an edge surface 64. The rings segments 72 can thus be removed from or placed into the ring channels 70 by moving them through the ring channels 70. Accordingly, vanes 22 coupled to a ring segment 72 can be removed with the ring segment 72 due to movement of the ring segment 72. Movement of the vanes 22 in the radial direction for removal or installation, which thus requires removal of the rotor 24, is thus no longer required.

The present disclosure is thus further directed to methods for removing variable stator vanes 22 in a turbine system 10. A method may include, for example, separating an upper outer casing 63 from a lower outer casing 62. Such separating may be facilitated by, for example, unfastening mechanical fasteners that fasten the upper outer casing 63 and lower outer casing 62 together, such as at the horizontal joints 66, and lifting the upper outer casing 63 form the lower outer casing 62.

The method may further include, for example, sliding a ring segment 72 in a ring channel 70 defined in the lower outer casing 62 or upper outer casing 63 towards an edge surface 64. One or more variable stator vanes 22 may be coupled to the ring segment 72. In exemplary embodiments as shown, the edge surface 64 is at the horizontal joint 66. Further, in exemplary embodiments as shown, the ring channel 70 is generally annular, and may thus extend circumferentially about the casing 50. A ring segment 72, and thus the variable stator vanes 22 coupled to the ring segment 72, may be removed from the casing 50 by sliding the ring segment 72 in the ring channel 70 past the edge surface 64.

In some embodiments, a stem 80 may extend from the variable stator vane 22 at least partially through the ring segment 72, as discussed above. The stem 80 may couple the vane 22 and ring segment 72 together. Further, in some embodiments, a stem extension 82 may be coupled to the stem 80. The stem extension 82 may extend through the body 56 of the casing 50. Thus, in some embodiments, a method according to the present disclosure may further include uncoupling a stem extension 82 from the stem 80, and removing the stem extension 82 from the ring segment 72. Such uncoupling may require, for example, removing a male coupling 84 from a female coupling feature 86.

Further, in some embodiments, the method may include removing a mechanical fastener 88 fastening the stem 80 and stem extension 82 together. Still further, in some embodiments, the method may include uncoupling a vane arm 90 from the stem extension 82.

It should further be understood that the various steps disclosed herein may be reversed to assembly variable stator vanes 22 in a turbine system 10. Such as method for assembling such vanes 22 may include, for example, sliding a ring segment 72 in a ring channel 70 defined in a lower outer casing 62 or upper outer casing 63 away from an edge surface 64; coupling a stem extension 82 and stem 80 together; fastening the stem extension 82 and stem 80 together such as with a mechanical fastener 88; coupling a vane arm 90 and a stem extension 82 together; and engaging an upper outer casing 63 and a lower outer casing 62

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A variable vane assembly for a turbine system, comprising:
a variable stator vane comprising a radially inner end, a radially outer end, and a body therebetween;
an outer casing proximate the radially outer end, the outer casing comprising an inner wall, and outer wall, and a body therebetween;
a generally annular ring channel defined in the outer casing, the ring channel extending from the inner wall into the casing;
a ring segment disposed in the ring channel; and
a stem extending from the radially outer end of the variable stator vane at least partially through the ring segment.

2. The variable vane assembly of claim 1, wherein the stem extends partially through the ring segment, and further comprising a stem extension coupled to the stem and extending through the body of the casing.

3. The variable vane assembly of claim 2, wherein the stem extension protrudes from the outer wall of the casing.

4. The variable vane assembly of claim 2, further comprising a mechanical fastener extending through the stem extension into the stem to fasten the stem extension and the stem together.

5. The variable vane assembly of claim 2, wherein the stem comprises a male coupling feature and the stem extension comprises a mating female coupling feature.

6. The variable vane assembly of claim 2, further comprising a vane arm rotatably coupled to the stem extension.

7. The variable vane assembly of claim 1, wherein the ring channel comprises a dovetail slot and the ring segment comprises a mating dovetail.

8. A variable vane assembly for a turbine system, comprising:
a variable stator vane comprising a radially inner end, a radially outer end, and a body therebetween;
a ring segment;
a stem extending from the radially outer end of the variable stator vane and configured to extend at least partially through the ring segment; and
a stem extension configured to couple with the stem and protrude from the ring segment.

9. The variable vane assembly of claim 8, wherein the ring segment comprises a dovetail.

10. The variable vane assembly of claim 8, further comprising a mechanical fastener extending through the stem extension into the stem to fasten the stem extension and the stem together.

11. The variable vane assembly of claim 8, wherein the stem comprises a male coupling feature and the stem extension comprises a mating female coupling feature.

12. The variable vane assembly of claim 8, further comprising an outer casing proximate the radially outer end, the outer casing comprising an inner wall, and outer wall, and a body therebetween, and a generally annular ring channel defined in the outer casing, the ring channel extending from the inner wall into the casing.

13. The variable vane assembly of claim 12, wherein the stem extension is configured to protrude from the outer wall of the casing.

14. The variable vane assembly of claim 12, wherein the ring channel comprises a dovetail slot and the ring segment comprises a mating dovetail.

15. A method for removing a variable stator vane in a turbine system, the method comprising:
separating an upper outer casing from a lower outer casing; and
sliding a ring segment in a ring channel defined in one of the upper outer casing or lower outer casing towards an edge surface of the one of the upper outer casing or lower outer casing,
wherein the variable stator vane is coupled to the ring segment.

16. The method of claim 15, wherein the one of the upper outer casing or lower outer casing is the lower outer casing.

17. The method of claim 15, wherein the edge surface is at a horizontal joint of the one of the upper outer casing or lower outer casing, and wherein the ring channel is generally annular.

18. The method of claim 15, wherein a stem extends from the variable stator vane at least partially through the ring segment, coupling the variable stator vane and ring segment together.

19. The method of claim 18, further comprising uncoupling a stem extension from the stem, and removing the stem extension from the ring segment.

20. The method of claim 19, further comprising removing a mechanical fastener fastening the stem and stem extension together.
